(19) United States
(12) Patent Application Publication
(10) Pub. No.: US 2009/0100349 A1
(43) Pub. Date: Apr. 16, 2009

(54) TERMINAL CLIENT COLLABORATION AND RELAY SYSTEMS AND METHODS

(76) Inventor: Jon W. Hancock, Dublin, GA (US)

Correspondence Address: PILLSBURY WINTHROP SHAW PITTMAN LLP, P.O. BOX 10500, MCLEAN, VA, 22102, US

(21) Appl. No.: 12/193,661

(22) Filed: Aug. 18, 2008

Related U.S. Application Data
(60) Provisional application No. 60/956,377, filed on Aug. 16, 2007.

(51) Int. Cl. G06F 3/00; H04L 9/00; G06F 15/16

(52) U.S. Cl. 715/751; 713/150

(57) ABSTRACT

Systems and methods are described that enable collaboration in interactive sessions. A first connection is established between a terminal client and a relay service and the terminal client engages in an interactive session with a terminal service. A second connection is established between a shadow client and the relay service and data and commands are relayed between the terminal client and the shadow client through the relay service, The first and second connections and the interactive session may be encrypted. The interactive session is encrypted using different encryption keys than the keys used by the first and second connections. The data and commands include information associated with the interactive session and the information may be used to synchronize displays between the terminal client and the shadow client.

### CROSS-REFERENCE TO RELATED APPLICATIONS

The present Application claims priority from U.S. Provisional Patent Application No. 60/956,377, filed Aug. 16, 2007, entitled “System And Method For Terminal Client Collaboration And Relay,” which is hereby incorporated by reference herein for all purposes.

### BACKGROUND OF THE INVENTION

1. Field of the Invention

The present invention relates generally to computers interconnected for communications over a network such as the Internet and more particularly to remote access to computer graphical interfaces.

2. Description of Related Art

Terminal client, and terminal services, graphical user interface (“GUI”) collaboration and remote desktop solutions attempt to resolve problems related to remote access to computer systems. Terminal clients are provided as a software application used on one computer to interact with the command line interface (“CLI”) or GUI of a terminal service offered by a second computer or device. A terminal client is commonly referred to as a “dumb terminal” because it does not execute the program with which its user is interacting (“the target program”). The target program and its CLI or GUI resides on the second computer. More modern terminal client software acts as a tool to view and interact with remote programs and sends, receives and processes client side of the protocol required by a terminal service provided on another computer. Examples of terminal services are Telnet, SSH, Telnet over SSH, SSH Xl1 forwarding, X Window Systems, Telnet X-forwarding, Microsoft's Remote Desktop, VNC or Remote Framebuffer, and NX optimized X.

FIG. 1 is a block diagram showing a typical interaction between a terminal client and its terminal service. In this interaction, a software application called a terminal client 106 executes on the operating system of a user's workstation 102. This terminal client connects through available wired or wireless network 110 to the terminal service 104 operating on another computer 100. This terminal service enables the control or interaction with an application 108. This application 108 may be a single process running on the computer 100 or may be a complex “GUI Desktop” which provides access to many applications.

Examples of terminal clients include: PuTTY client, PocketPuTTY client, SSH.com's Tectia client, VNC client, NoMachine's NX client, 2X terminal client and Microsoft Remote Desktop Connection Client. Examples of terminal services include: SSH Communications Security's SSH server, OpenSSH's SSH server GoodTech Systems' Telnet Server, KpyM SSH server, NCSA Telnet server, X.org Foundation's X server, XFree86 Project, Inc.'s X server, NoMachine's NX server, 2X TerminalServer and Microsoft Terminal Services. These terminal clients and services implement one or more protocols, including: Telnet protocol, Secure Shell (SSH) Connection Protocol, Secure Shell (SSH) Protocol Architecture, Remote Framebuffer (RFB) protocol (also referred to as VNC), X Window System (commonly Xl1 or X) protocol, NX protocol (optimized Xl1 protocol) and Microsoft Remote Desktop protocol.

GUI collaboration can refer to a method used to provide collaborative or remote access to a graphical user interface (GUI) between two or more computers. These solutions use software which at a minimum captures the keyboard, video, and mouse input and output of the target computer's GUI and reproduces all or part of this user experience on another computer, the collaborator's computer. This is achieved through software applications on the target computer and the collaborator computer which monitor keyboard, video and mouse movement through Operating System APIs, hardware device drivers, or direct hardware access.

FIG. 2 is a block diagram showing typical interaction for GUI Collaboration. In FIG. 2, all or part of target computer's 200 GUI or Web Browser 206 is being reproduced on the collaborator's Computer 204. This is accomplished via software agents 210 and 212 installed on both computers which are capable of communicating to each other directly 220 or through 216 and 218 a relay service 214 operating on a third computer 202. Examples of Graphical User Interface collaboration solutions include: Symantec's pcAnywhere. Citrix's GoToMyPC and GoToAssist and LogMeIn.

Using both a terminal client and a terminal service as well as GUI Collaboration, users can provide for collaboration or remote access of a terminal client. The combination of these two widely available and well understood solutions enables two or more users to view and interact with a terminal client, which in turn allows these users to collaborate with programs running on a third computer.

FIG. 3 illustrates this combination through a block diagram showing a GUI collaboration solution to allow two users, at computers 200 and 204, to collaborate and control a terminal client 106 which in turn controls a program 108 through a terminal service 104 on computer 100. This combination of solutions may achieve results for the users. However, this approach introduces problems through its combined complexity. The problems include additional software to manage, differing communication and security management between the solutions, loss of semantic meaning of terminal service protocol by applying a different protocol for GUI collaboration, and potential for excessive network bandwidth.

### BRIEF SUMMARY OF THE INVENTION

Certain embodiments of the present invention comprise systems and methods for collaborating in an interactive session. Methods may comprise the steps of establishing a first connection between a terminal client and a relay service, wherein the terminal client is engaged in an interactive session with a terminal service, creating a second connection between a shadow client and the relay service, and relaying data and commands between the terminal client and the shadow client through the relay service, wherein certain of the data and commands provided by the shadow client are transmitted to the terminal service in the interactive session. In some of these embodiments, the first and second connections are encrypted and in certain embodiments, the interactive session is encrypted. The interactive session can be encrypted using first encryption keys while the first and second connections may be encrypted using different encryption keys. In some of these embodiments, the terminal client decrypts the data and commands relayed from the shadow client and re-encrypts certain of the data and commands using the first encryption keys.

In certain embodiments an encrypted channel is maintained between the terminal client and the shadow client, wherein communications in the encrypted channel are relayed without decryption at the relay service. The data and commands include information associated with the interactive session and the information may be used to synchronize displays between the terminal client and the shadow client. The information may comprise communications between users of the terminal client and the shadow client and the communications may include voice communications and chat.

Systems according to certain aspects of the invention may provide for collaboration in an interactive session. Systems may comprise a relay configured to support a plurality of communications channels between terminal clients. In certain embodiments, the plurality of communications channels includes a collaborative communications channel between a first terminal client and at least one shadow client. The first terminal client establishes the interactive session with a terminal service. The relay synchronizes displays between the first terminal client and the at least one shadow client and the at least one shadow client can contribute input to the interactive session. The interactive session may be encrypted using first encryption keys and the first and second connections are encrypted using other encryption keys different from the first encryption keys.

According to certain aspects of the invention, collaborative and remote access can be provided to a terminal client thereby allowing users to collaborate with applications running through a terminal service. This can be accomplished by extending a traditional terminal client to communicate directly or through a relay service to a new application called a terminal shadow client. A terminal shadow client may be considered a special terminal client that is not connected directly to the terminal service. The terminal client acts as the gateway for both terminal client and terminal shadow client to communicate to the terminal service. The terminal client and shadow client may be created as components of a computing device and may be implemented as a software module that may be provided in an operating system (“OS”) library and/or may be executed as an application using OS services. In certain embodiments, clients may be provided in runtime and/or OS-agnostic environment such as Java or using a Javascript. One or more of the clients may be provided as an applet that can be initiated and/or instantiated in a Java runtime environment, and clients may be provided in a web browser and so on.

Certain embodiments of the invention comprise a terminal client, a shadow client and a terminal service. The terminal client is typically the only application or service that need connect with the terminal service. Accordingly, the user of the terminal client is the only person that needs to be authorized to connect to the terminal service. The terminal service may support any suitable service such as SSH, Telnet, X Server and/or Windows Terminal Service. The terminal service need not be aware of all components of the claimed system and their configuration. Users of shadow clients are typically controlled through terminal client data flow and therefore may be controlled by the user of the terminal client. A terminal service protocol, such as SSH, Telnet, Xl1 may be preserved and reused through the terminal shadow clients, thereby allowing a more simplified method of collaboration for many types of terminal services.

According to certain aspects of the invention, the terminal client shares only a portion of a host computing system. Collaboration relates to the sharing of the terminal client experience and no artifacts of the terminal client desktop environment need be exposed to other users.

### BRIEF DESCRIPTION OF THE DRAWINGS

FIG. 1 illustrates conventional interaction between a terminal client and terminal service.

FIG. 2 illustrates conventional interaction for GUI collaboration.

FIG. 3 illustrates a GUI collaboration solution used to collaborate with a terminal client to control programs on a third computer.

FIG. 4 is a block diagram illustrating collaboration of terminal client and terminal shadow client according to certain aspects of the invention.

FIG. 5 shows an example of a logical process for creating a collaborative session between a terminal client user and a terminal shadow user according to certain aspects of the invention.

FIG. 6 is a flow diagram showing an example of terminal client/terminal shadow client establishing a connection to a collaborative session according to certain aspects of the invention.

FIG. 7 is a flow diagram showing an example of data flow between terminal client, terminal service, relay service and terminal shadow client according to certain aspects of the invention.

FIG. 8 is a flow diagram showing an example of data flow between terminal client, terminal service, relay service and terminal shadow client according to certain aspects of the invention.

FIG. 9 is a flow diagram showing an example of data flow between terminal client, terminal service, relay service and terminal shadow client according to certain aspects of the invention.

FIG. 10 is a flow diagram of a logical process for encrypting terminal service protocol and relay protocol.

FIG. 11 is a block diagram illustrating logging session, control and payload data.

FIG. 12 is a block diagram illustrating multiple relays used to enable a large number of concurrent sessions.

FIG. 13 is a block diagram illustrating multiple terminal shadow clients used in one collaborative session.

FIG. 14 is a block diagram illustrating terminal client and terminal service on the same computing device.

FIG. 15 is a diagram showing an example of data flow, such as a text or voice chat, between users in a session.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

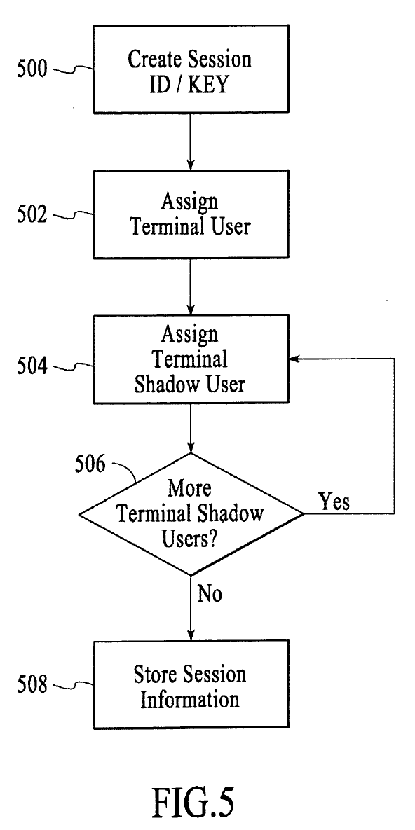

With reference to FIG. 4, certain embodiments of the invention comprise a plurality of computing devices—in the example, computers 400, 402, 404, and 406. Computers 400, 402, 404 and 406 may include personal computers, workstations, servers and handheld devices such as smart phones or personal data assistants (PDAs). Each of computers 400, 402, 404 and 406 typically is equipped with memory, input and output devices, operating system, network interface and persistent data store such as a hard drive or flash memory. Computers 400, 402, 404 and 406 can connect to a network, such as the Internet, using wired or wireless methods and can typically communicate over the network using standard protocols such as TCP/IP. In the example, computers 400 and 404 are configured to operate as servers executing any suitable operating system such as UNIX, Linux and Microsoft Windows. In the example, computers 402 and 406 are configured as workstations having a desktop or handheld operating system such as Linux, UNIX and Microsoft Windows with a graphical desktop.

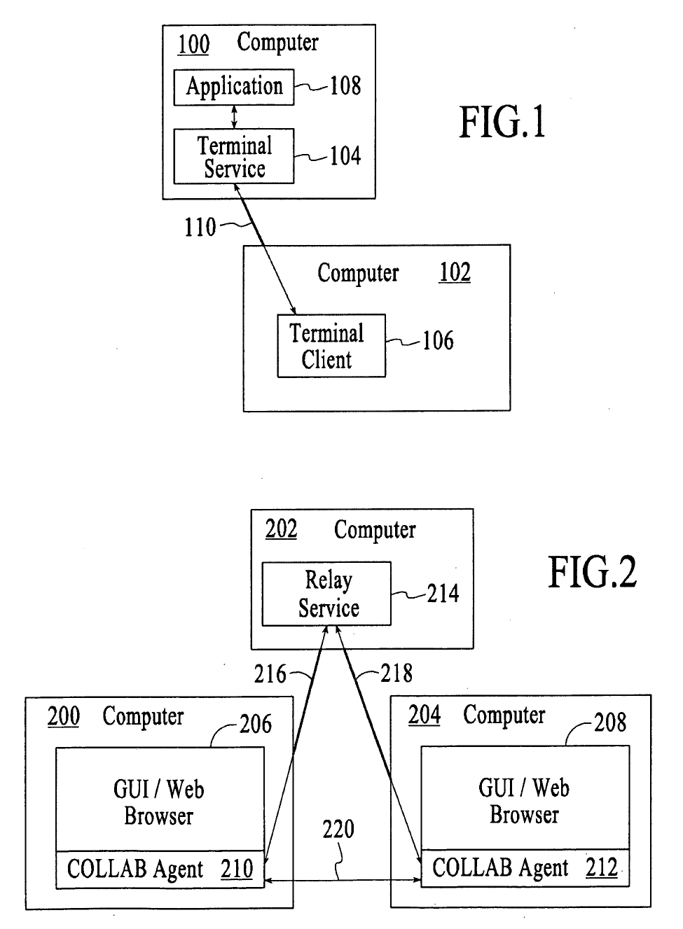

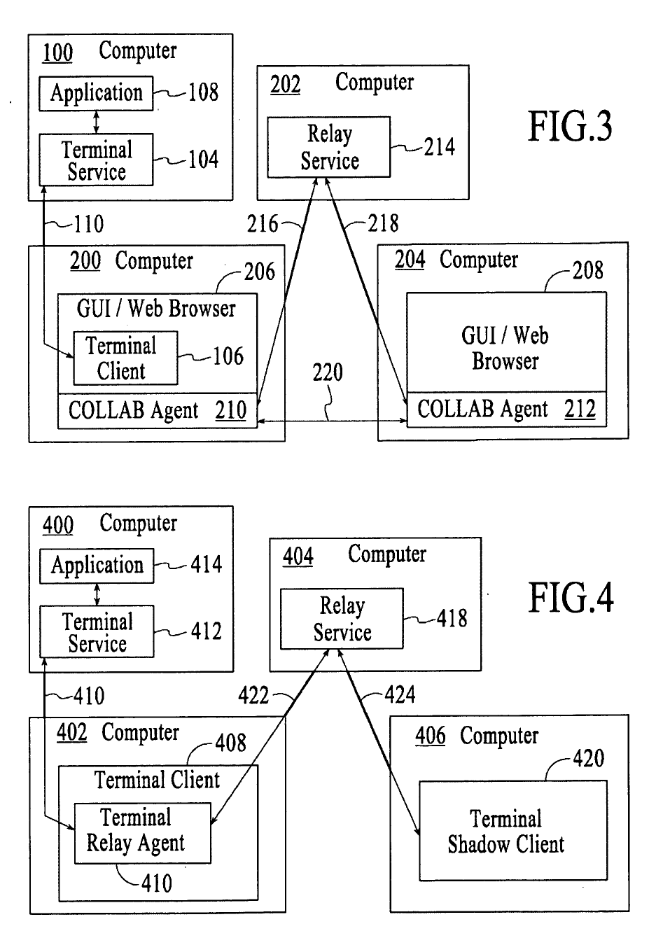

User operating computer 402 employs modified terminal client software 408 to connect to terminal service 412. Terminal service 412 may be an SSH server, Telnet server, Xl1 server or any other suitable or desired terminal service with which terminal client 408 can communicate or be configured to communicate. Modified terminal client 408 connects and communicates (see 416) to terminal service 412 in a manner similar to that described in FIG. 1 and according to requirements set forth by the protocol employed by terminal service 412.

In certain embodiments, modified terminal client 408 is modified from other clients by the inclusion of a terminal relay agent 410. Terminal relay agent 410 is configured to enable a set of behaviors that extends the normal behavior of a conventional terminal client and that permits communication channel 422 to support a relay service 418 on an intermediate or other computer 404. Relay service 418 can operate as a command and protocol relay between terminal client 408 and a terminal shadow client 420, which also communicates (see 424) with relay service 418. Both terminal client 408 and terminal shadow client 420 can be connected to the relay service 418 in a common session. Terminal client 408 through its terminal relay agent 410, relay service 418, and terminal shadow client 420 cooperate through a shared protocol to provide a collaborative experience between users of both terminal client 408 and terminal shadow client 420.

As discussed, shell terminal client 408 can be connected using Telnet over encrypted SSH to connect to a server. However, certain embodiments use other types of connections to a terminal service and the connections can be encrypted or unencrypted based on predefined requirements and/or configuration and user preferences. In that regard, a shell user can connect to a terminal service as unencrypted Telnet, simple FTP, X-Windows protocol or proprietary GUI remote protocols, etc. The terminal service can also host older forms such as AS/400 (IBM 5250) and IBM 3270 sessions as required by the terminal client.

In certain embodiments, peer-to-peer communications can be provided between terminal client 408 and terminal shadow client 420. As described in the examples provided herein, terminal client 408 and/or its embedded agent is typically the final authority for accepting shadow input or relay output. Thus, a peer-to-peer configuration can added to the example depicted in FIG. 4 as desired. Such addition does not significantly alter the operation of the systems and methods described.

FIG. 5 depicts an example illustrating a logical process for defining a session that may be established between two or more users of terminal client 408 and terminal shadow client 420. Although a session can be defined programmatically or through an automated agent, this description is directed to an example in which a user communicates through a web browser with a web server application that provides a human interface in the form of HTML web pages. The web server application may store created session data in a database. In the example, the user causes the web application to create a new session at step 500. The creation of a session can involve assigning an ID which is unique and which will be used by users of both terminal client 408 and terminal shadow client 420 and the ID identifies the session when the users connect to the relay service 418. At step 502, the user of the terminal client 408 is identified and, at step 504, the user of the terminal shadow client 420 is identified. While different users may be identified, it is contemplated that a single user can be identified as user of both the terminal client 408 and one or more terminal shadow clients 420. Step 504 may be repeated until, at step 506, it is determined that there are no more users of terminal shadow clients 420 are to be associated with the session. At step 508, session information can be stored in a database, table or elsewhere. This stored session information is typically made available in restricted form to the relay service 418 to allow the relay service to authenticate and accept connections from terminal clients and terminal shadow clients.

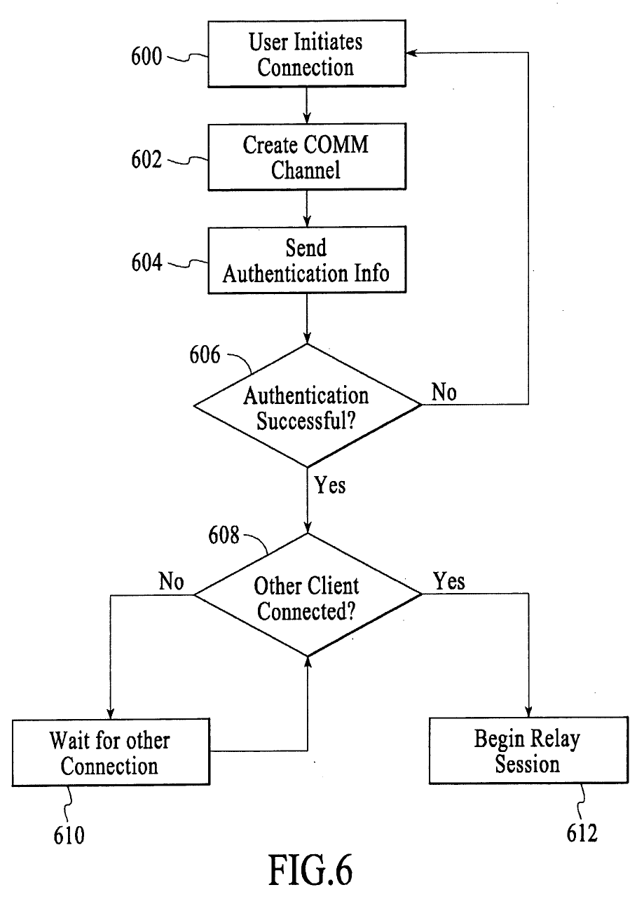

When a session has been defined, a user of the terminal client 408 may connect the terminal client to the relay service 418. The terminal relay agent 410 behavior embedded in the terminal client 408 can be used to establish this connection 422 and FIG. 6 includes a flow diagram showing the terminal client 408 connecting to a session with the relay service 418. The terminal client 408 may be connected to the terminal service 412 or may not yet have established this connection 416. Whether or not the terminal client is yet connected to the terminal service, the user may establish a connection to a session with the relay service. At step 600, the user requesting the terminal client 408 to connect to the relay service 418 provides the terminal client 408 with the user's authorization credentials and the session ID created, for example, as described above. User authorization credentials can comprise one or more components such as a userid and password and credentials used, for example, in two-factor authentication. The terminal relay agent (“TRA”) 410 of terminal client 408 typically receives the session ID and user authorization credentials.

At step 602, terminal relay agent 410 creates a communications channel 422 with the relay service 418. This communications channel may be created by using well know encryption key exchange protocols such as Secure Shell (SSH), Secure Socket Layer (SSL) or Transport Layer Security (TLS) secure socket methods or the connection can assume a secure network already exists. A benefit of using a TCP/IP socket secured with SSH, SSL, or TLS protocol is that the terminal client 408 software most likely already contains code to negotiate such a secure channel 416 between the terminal client 408 and terminal service 412. When a communication channel has been established, the terminal relay agent 410 of terminal client 408 can attempt to join a session with the relay service at step 604. Joining the session can include terminal relay agent 410 sending an authentication message to the relay service 418, where the message contains the session ID and user authentication data. When the relay service 418 receives this request, it typically checks the received data against the session information stored in the database. If the stored session information does not match against the authorization request, the terminal relay agent 410 may be notified of the failure and a session with the relay service 418 is not established. If a match of the stored information is determined, the relay service 418 can establish the connection 422 from the terminal relay agent 410 as an authorized session.

At step 608, it is determined if a terminal shadow client 420 is connected for the session. A terminal shadow client 420 may establish connection 424 to the relay service 418 for the session either before or after the terminal client 408 has connected to the session. As a result, the terminal service will hold a connection from the terminal client 408 and wait at step 610 until there is a corresponding terminal shadow client 420 connected to the relay service 418 for the same session. When a terminal shadow client 420 is available for the session, the relay service 418 enters into the role of relaying and guarding data flow between the terminal client and terminal shadow client at step 612.

The terminal shadow client 420 establishes connection 424 to the relay service 418 following a process similar to that illustrated in the example of FIG. 6. One difference may be that the relay service 418 has knowledge of which connections are terminal clients 408 and which connections are terminal shadow clients 420. This distinction can be necessary for authenticating against the database's session information and because it is the terminal client 408 that controls the state of relaying and guarding data flow between the terminal client 408 and terminal shadow client 420.

When both terminal client 408 and terminal shadow client 420 have successfully connected to the relay service for the session, the relay service 418 is typically responsible for relaying and guarding data flow between the two clients 408 and 420. The following three examples can be instructive by illustrating this data flow. In the examples, it will be assumed that the terminal service 412 includes a Secure Shell (SSH) server providing a Telnet service command line interface (CLI) to terminal client 408. Further, it will be assumed that the terminal client 408 is successfully authenticated and connected to the terminal service 412.

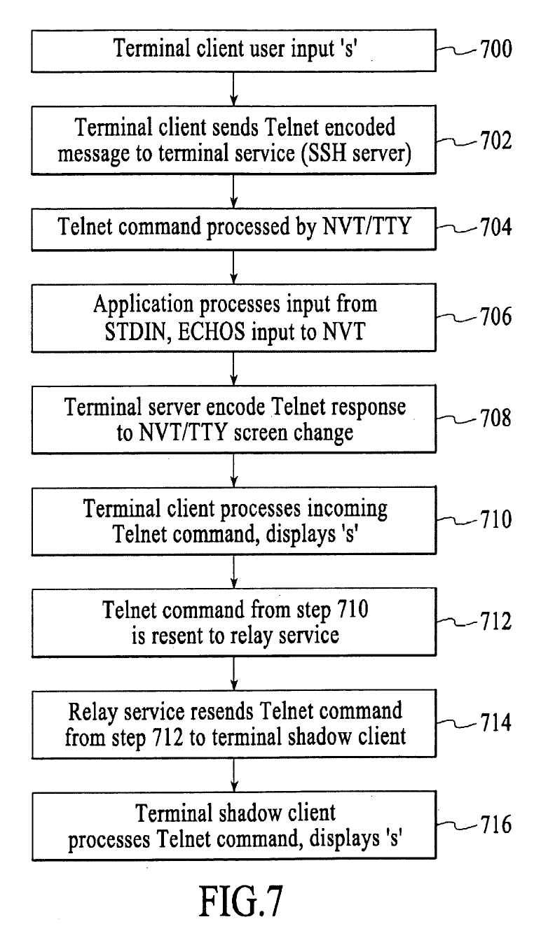

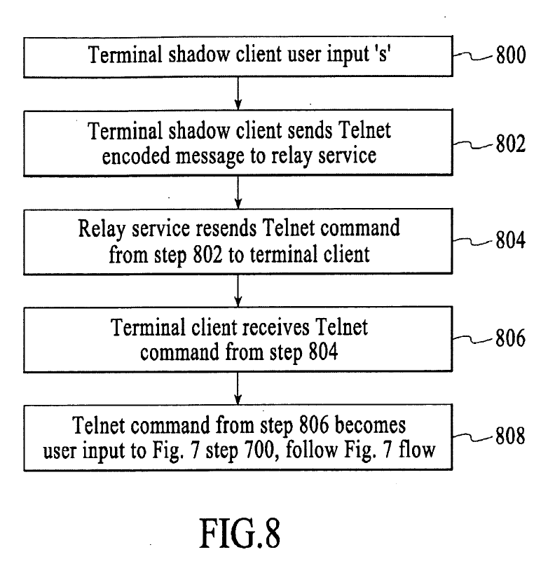

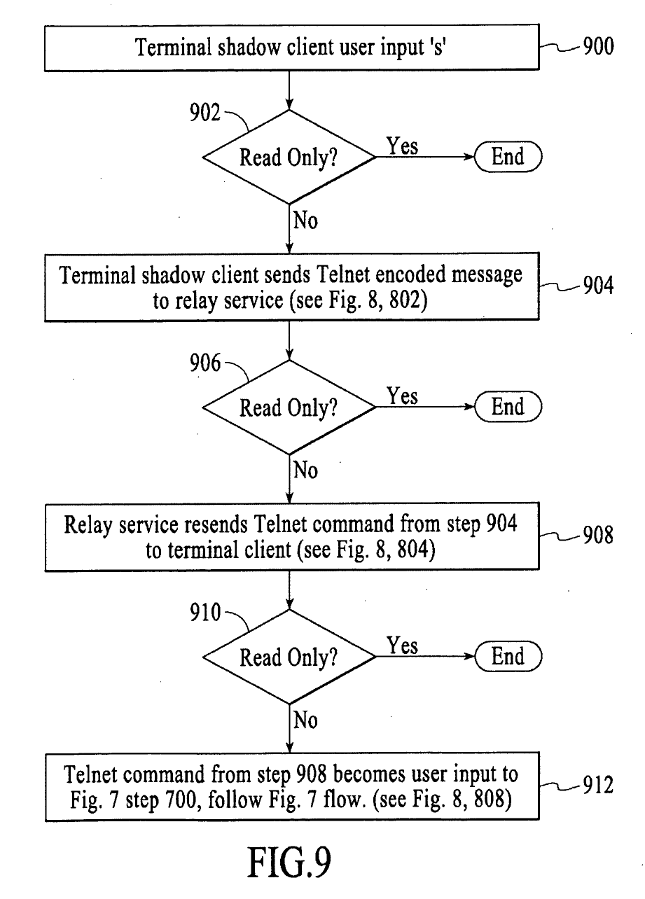

In the example depicted in FIG. 7, data flow is shown following entry at step 700 by a user of the terminal client 408 of a keystroke; here a character “s” is typed. Typically, the terminal client 408 does not locally echo the keystroke character or display a visual indication to the user related to this action; i.e. the “s” character is not displayed on the user's screen. At step 702, the terminal client encodes the keystroke character input into a command according to the Telnet protocol and further encodes the Telnet command for the SSH communication channel 416 which has been previously established with the terminal service (SSH server) 412. The terminal service 412 decrypts and interprets the incoming message as an acceptable Telnet command of a keystroke character.

At step 704, the terminal service appends the keystroke character to the standard in-data stream (“stdin”) of the network virtual terminal (“NVT”) which is attached to application 414. In the case of Telnet, the NVT has a program 414 attached and associated with this terminal that processes input of the standard in stream at step 404. In the current example, it is assumed that the program responds by echoing the keystroke character back to the terminal displayable screen at step 706. At step 708, the Telnet service may respond with a message indicating the change to the server's terminal screen. Note that certain Telnet services are embedded as a component of SSH service. The message is sent by the SSH server 412 back to the waiting SSH terminal client 408.

The terminal client 408 may then process the incoming Telnet message at step 710 and may display the keystroke character for the user. Until this action, the user terminal client output had not changed. At step 712, if relay service 418 is connected, the terminal client 408 may resend the Telnet command as received in step 710 to the relay service 418. At step 714, the relay service 418 determines if a terminal shadow client 420 is connected for this session and resends the Telnet command to the terminal shadow client 420 as indicated. At step 716, the terminal shadow client 420 processes the incoming Telnet command and displays the keystroke character for the user to see. At this point, the terminal client 408 and terminal shadow client 420 are in the same visual state.

In the data flow example of FIG. 7, steps 700 through 710 may be characterized as consistent with Telnet over SSH behavior as described in Internet Engineering Task Force (“IETF”) documents addressing Telnet protocol, SSH connection protocol and the SSH protocol architecture. Steps 712 through 716 are performed in accordance with certain aspects of the invention and the steps are supported by suitable modifications to the terminal client and the implementation of the relay service 418 and terminal shadow client 420.

In the illustrative example of FIG. 8, a second data flow is shown in which the user of the terminal shadow client 420 inputs a keystroke character at step 800, again the “s” character. Upon entry of the keystroke character, the terminal shadow client 420 does not display visual indication to the user of this action. That is, the “s” character does not yet display on the user's screen. At step 802, the terminal shadow client 420 encodes the keystroke character input into the Telnet protocol and further encodes this Telnet command for transmission over the communication channel 424 which has been established with the relay service 418; the Telnet message is then sent to relay service 418.

At step 804, relay service 418 receives and interprets the incoming message as an acceptable Telnet command and relays this message to terminal client 408 for the session. Terminal client 408 receives, at step 806, a message from the relay service 418 through its terminal relay agent 410 component that was transmitted over communication channel 422; the terminal client decodes and interprets the message as an acceptable Telnet command. At step 808, the terminal client 408 accepts the Telnet command as received from the terminal shadow client 420 and processes it as if the command were generated by the action of the user of the terminal client 408. The character is then processed in the manner described for steps 700, et seq. in FIG. 7. As such, at the end of the data flow from FIG. 7, both terminal client 408 and terminal shadow client 420 will again be in the same visual state.

The examples shown in FIGS. 7 and 8 depict data flow for normal relay of terminal service protocol. Additional features are supported by the relay service 418 and terminal relay agent 410. For example, certain embodiments can guard and filter data flows to or from the terminal shadow client 420. Terminal client 408 can serve as a gateway to the terminal service 412 and the user of terminal client 408 can block terminal service protocols from being relayed to the terminal shadow client 420 without breaking the communications channel 422 to the relay service session. In this manner, a user of terminal client 408 may selectively clear and block the view of the terminal shadow client 420. Additionally, the terminal client 408 may also filter certain input from the terminal shadow client 420 in order to guard against dangerous or unwanted input to the terminal service. Mechanisms and techniques provided in support of such guarding and filtering of data between terminal client 408 and terminal shadow client 420 can be embedded in the terminal relay agent 410, the relay service 418 and the terminal shadow client 420.

FIG. 9 illustrates one example of a data flow in which guarding and/or filtering of data is effected. Here again a user of the terminal shadow client 420 a keystroke character (the “s” character) at step 900. For the purposes of this example, it will be assumed that terminal client 408 and terminal relay agent 410 have been configured to reject input from terminal shadow client 408. In this state of operation, terminal shadow client is in a read-only state. Upon receiving the keystroke character, the terminal shadow client 420 does not display visual indication to the user of this action. At step 902, if terminal shadow client 420 is aware, typically through the relay service 418, that terminal client 408 for the session has set read-only state for the terminal shadow client 420, then terminal shadow client 408 may discard the input and ends the process. However, if terminal shadow client 420 is unaware or oblivious to the read-only state, then terminal shadow client 420 may encode the keystroke input at step 904 for transmission over the communication channel 424 (see FIG. 8, step 802).

At step 906, the relay service 418 receives the Telnet-encoded input message from the terminal shadow client 420 and may determine that the terminal client 408 has set a read-only state for the terminal shadow client 420, and accordingly relay service 418 discards the message and ends the process. However, relay service 418 may be unaware of the read-only state or may not be configured to respond to a read-only setting, in which case relay service 418 may send the message to terminal relay agent 410 of the terminal client 408 (see FIG. 8, step 804).

At step 910, terminal relay agent 410 of terminal client 408 typically detects the read-only state and discards the input. However, if the terminal relay agent 410 fails to recognize or act on the read-only state, then the terminal client 408 will typically discard input received from the relay service 418 when in the read-only state. Thus the terminal client will not process the message and the data flow ends at step 910. It will be appreciated that input from terminal shadow client 420 may be processed at step 912 when the read-only state is removed and the terminal client 408 is accepting input from the terminal shadow client 420.

In the latter described example, terminal client 408 is capable of setting terminal shadow client 420 to a read-only state. In certain embodiments, read-only state can be implemented by configuring one or more of terminal relay agent 410, relay service 418 and terminal shadow client 420 to be aware of read-only state. Read-only state may be accomplished by transmitting a message from terminal client 408 to relay service 418. Relay service 418 may then disseminate the message to the terminal shadow client 420. Relay service 418 and terminal shadow client 420 may be configured and/or adapted to respect state change requests communicated by terminal client 408. Other states may also be controlled and/or handled by one or more of terminal client 408, terminal relay agent 410, relay service 418 and terminal shadow client 420. The other states may include a clear screen state where the terminal shadow client 420 has its view cleared and does not send or receive any protocol to or from the terminal service 412 and the guarded state in which the terminal shadow client 420 can receive limited input whereby, for example, terminal shadow client 420 cannot process the “enter” key or other such executive command. Relay service 418 and terminal shadow client 420 typically follow the rules associated with a state, and the terminal relay agent 410 is typically the designated final guard preventing transmission and/or reception of data through terminal client 408 to relay service 410.

In certain embodiments, a state change indicated by terminal client 408 produces a “command” message to be sent to relay service. For the purposes of this description, command messages, including command data, are messages and communications passed between terminal relay agent 410, relay service 418, and terminal shadow client 420. Also for the purposes of this description and as used in the examples, the term payload data applies to encapsulated data that includes the original and optimized protocols of terminal service 412. In certain embodiments, messages between terminal relay agent 410, relay service 418 and terminal shadow client 420 take the form of a command message construct. Accordingly, payload data can be sent in the form of a command, typically identified as a “PAYLOAD_DATA” command and accompanied by a data stream which provided as the payload including the terminal service protocol for relaying.

Certain embodiments provide for separate encryption of payload data and command data. In these embodiments, a user of the terminal client 408 user and a user of the terminal shadow client 420 can trust each other without trusting the relay service 418 to decrypt payload data. When terminal client 408 or terminal shadow client 420 connects to the relay service 418, the communication channel is typically encrypted using techniques such as SSH, SSL, or TLS (see FIG. 6). This technique may use asymmetric key exchange such as standard Diffe-Hellman or RSA key exchange to negotiate a symmetric encryption key know only to the two end-points of the communication channel.

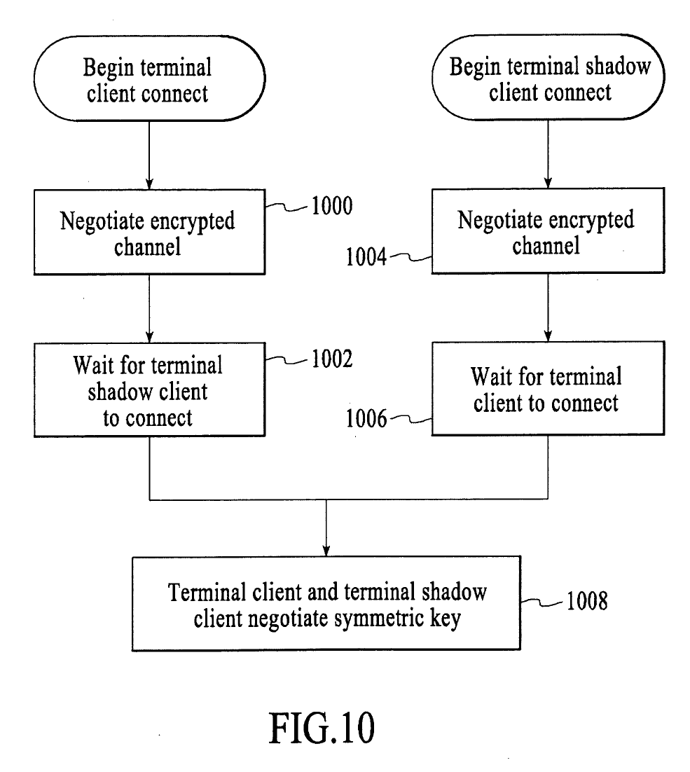

Referring now to FIG. 10, a process for establishing a secure channel is described. At step 1000, terminal relay agent 410 establishes a communication channel 422 to relay service 418 and a symmetric session key is established according to the cryptographic techniques and protocols adopted. This symmetric session key is maintained private to terminal relay agent 410 and relay service 418. Relay service 418 maintains the communication channel 422 while waiting at step 1002 for a terminal shadow client 420 to establish a session. Terminal shadow client 420 establishes a communication channel 424 to relay service 418 at step 1004. Communication channel 424 may establish a second symmetric session key. When both terminal client 408 and terminal shadow client 420 have established their communication channels 422 and 424, relay service 418 can start to relay data between them at step 1008. Having performed these steps, relay service 418 knows both symmetric session keys used for communication channels 422 and 424.

In certain embodiments, a third symmetric encryption key can be established that will not be known to the relay service 418, and will only be known by the terminal relay agent 410 and the terminal shadow client 420. The third symmetric key may be established at step 1008 by terminal relay agent 410 and terminal shadow client 420 using the command protocol of the relay service 418 to negotiate the third symmetric key. Again, this negotiation typically uses asymmetric keys to establish a symmetric key. Although relay service 418 sees the command message protocol passing through it to negotiate the third session key, it does have a copy or otherwise know the resultant third symmetric key. The use of a third symmetric key enables terminal relay agent 410 and terminal shadow client 420 to use the third symmetric key to encrypt and decrypt payload data and relay service 418 can thus decrypt command data without being able to decrypt the payload data which is a component of PAYLOAD_DATA command messages.

In certain embodiments payload data encryption through a relay service 418 may be negotiated using cryptographic keys not known by relay service 418. Such payload encryption may be established automatically through the shadow client shell or may be predetermined by user selection, configuration and/or application requirements. Logging services, discussed below, may also operate with payload data encrypted via keys unknown to the relay service. That is, the relay may log encrypted control and payload data that cannot be encrypted or decrypted by the relay service. The relay service and other components may nevertheless log and authenticate (enabling non-repudiation of data) the encrypted payload data.

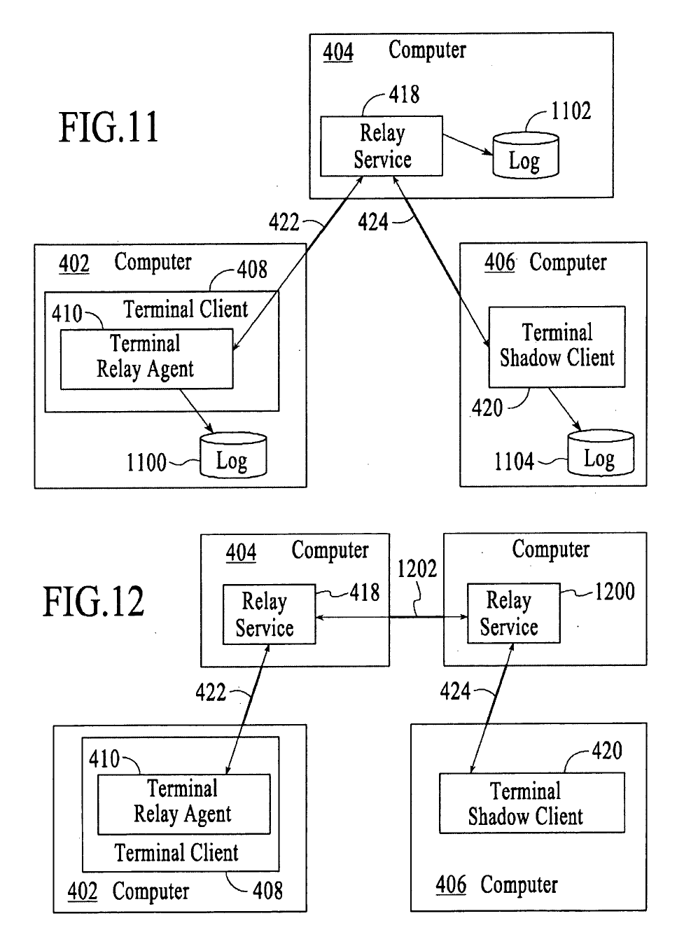

In certain embodiments, payload and command data may be logged as shown in FIG. 11. Logging terminal service protocols and command data passing through the terminal client 408 or the relay service 418 can support and enable analysis and replay of a session. Logging can be performed by various components described and/or by components added specifically to perform logging. Terminal relay agent 410 may write command and terminal service protocol data to a file or network stream log 1100. Relay service 418 may write the command and terminal service protocol data that passes through it to a file or network stream log 1102. Terminal shadow client 420 may write command and terminal service protocol data that it sends or receives to a file or network stream log 1104. Logged data can record the terminal service protocol of the session and identity of user, terminal client 408 and/or terminal shadow client 420 where the data originated. By enabling log data to be written by different components 410 or 418 or 420 enables a user to select a trusted source of logging. Logs 1100, 1102 and 1104 can be enabled for logging and managed by command, predefined configuration and by preference. Individual rights may be assigned to determine access and authority to configure and enable logging.

Logging systems may also record a variety of information including metadata comprising command and control information such as state settings and information regarding connection/disconnection from a relay server. Logging systems may also record payload data. In one example, semantic information regarding a collaborative session can be logged. The logged payload data typically comprises original protocol such as telnet which may provide highly meaningful semantic content. Uses of this semantic content include enhanced searching, auditing using logged data as auditable and non-reputable documents through cryptographic fingerprinting such as trusted third party storage of one-way hashes against the data and creating and editing of scripts to create replayable command scripts. Thus, user action can be traced and associated selected input and output. Timing information may be logged with metadata rather than payload data and used to enable playback as well as providing added contextual searching to the semantic content searches against the payload data.

As shown in FIG. 12, certain embodiments employ a plurality of relay services. Thus, relay functionality may be provided through one or more computers and through one or more software processes. Certain embodiments provide relay service using many software processes executing on many computers, often in physically distinct locations in order to obtain high-performance and concurrency of sessions and achieve networking efficiency. In one example terminal client 408 connects to relay service 418 and terminal shadow client 420 connects to a different relay service 1200. Neither terminal client 408 nor terminal shadow client 420 need be aware that different relay services 418 and 1200 are used. Relay services 418 and 1200 cooperate to perform as a single service by establishing a communication link 1202 between them and by forwarding data across communication link 1202 as necessary.

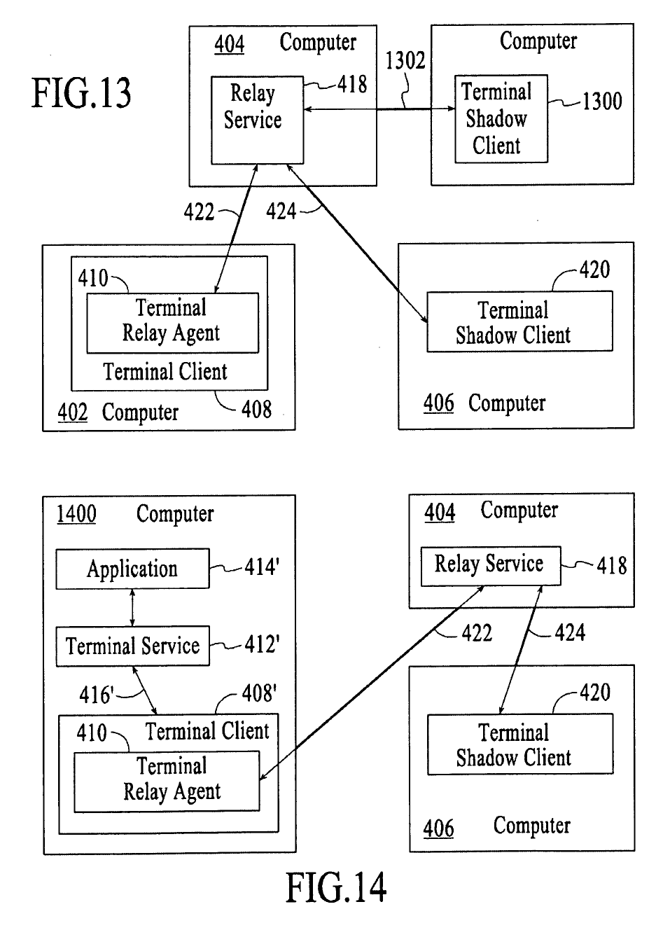

As discussed above, certain embodiments of the invention provide systems in which plural terminal shadow clients are connected to a session. FIG. 13 illustrates one example in which terminal shadow clients 420 and 1300 are connected in the same session with terminal client 408. In the example, terminal client 408 and terminal shadow client 420 are connected to relay service 418 and one or more additional terminal shadow clients 1300 can also be connected (by 424 and 1302) to the relay service for the same session. It is not necessary for all three connections 422, 424 and 1302 to be established to relay service 418 for the collaboration to begin. For example, a collaborative session can be established regardless of the total number of terminal shadow client users defined for the session if connection 422 and one other terminal shadow client connection 424 or 1302 are established. Relay service 418 permits additional terminal shadow clients 1300 or 420 to be connected and disconnected to relay service 418 without disrupting an ongoing collaboration.

In certain embodiments, both terminal service 412′ and terminal client 408′ are resident on the same computer 1400 and operating system as depicted in FIG. 14. For example, users of UNIX or Linux operating systems, users of X Window Systems, users of terminal services such as Microsoft Terminal Service and VNC or NX services may benefit from using the facility.

In certain embodiments, clients may be provided in runtime and/or OS-agnostic environment such as Java or using a Javascript. One or more of the clients may be provided as an applet that can be initiated and/or instantiated in a Java runtime environment, and clients may be provided in a web browser and so on.

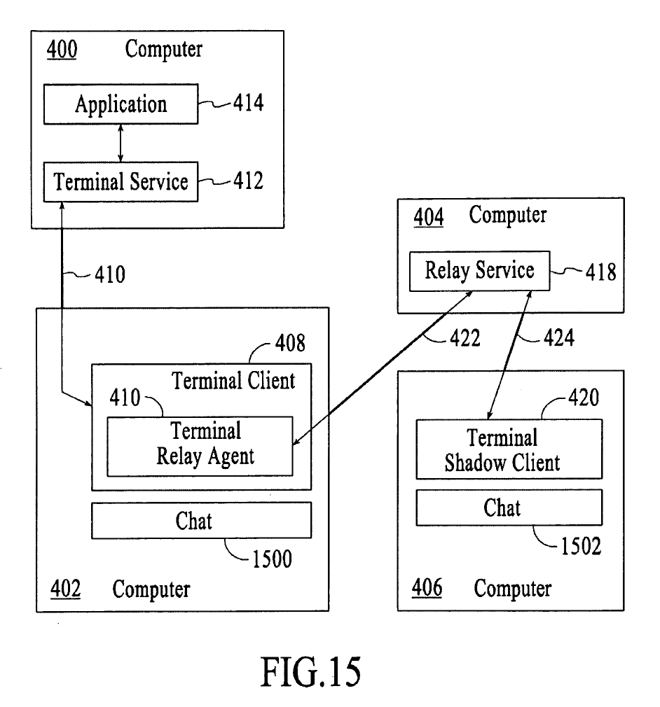

Referring to FIG. 15, certain embodiments support out-of-band data transfers. Out-of-band services comprise additional data passed through the relay service 418 that allows users of terminal client 408 and terminal shadow client 420 to chat, send voice data and/or share files. For example, chat components, plug-ins and/or modules 1500 and 1502 enable out-of-band communication between terminal client 408 and terminal shadow client 420. The command protocol of relay service 418 may be expanded to enable terminal relay agent 410, relay service 418 and terminal shadow client 420 to identify different types of payload data associated with chat or other out-of-band services. It is contemplated that other payload data types can be introduced which allow terminal client 408 or terminal shadow client 420 to provide additional collaborative services to the users such as combinations of text chat, voice communications and file exchange.

In certain embodiments, communication between terminal client 408 and terminal shadow client 420 can be extended through the relay service 418 and through other services. When both terminal client 408 and terminal shadow client 420 are connected, terminal client 408 and/or terminal shadow client 420 can query the other client 420 and/or 408 for other forms of contact information. For example, terminal client 408 may query terminal shadow client 420 for user telephone, email, instant message, skype and other addresses in order to establish a connection either through the system supporting relay service 418 or by independent connection.

Certain aspects of the invention yield particular benefit in certain computing environments. For example, it can be beneficial to consolidate GUI desktops to servers using virtualization technologies in order to move processing platforms into the closet. An end user's workstation thus becomes a terminal client. In particular, workstations may be designed for this in-closet environment and therefore be provided with a thin OS and a terminal client. Such topologies can benefit from the systems and methods provided by the invention.

Certain embodiments of the invention provide a user interface that shields users from a need to know what connection methods and protocols are used to establish a remote connection. The shell user need not know or understand how to connect to the terminal service employed. A terminal client may provide a simplified user interface by employing self-discover and/or auto-login. The terminal service may automatically discover a terminal service identified with a system or systems to which the user wishes to connect and may automatically log the user on to the terminal service using predefined login information, by prompting the user for userid and/or password, by using preexisting session information or prior session information and/or any combination of such login information. Auto-discovery and self discovery can be performed using existing discovery tools, custom discovery tools and combinations of tools. Examples of existing discovery include DHCP service ARP, RARP, USB discovery and WiFi discovery that are found in computer networking applications.

Certain embodiments provide utilities, plug-ins, modules and services that may be used in establishing connections with terminal service and relay service according to certain aspects of the invention. User interfaces can be provided according to predefined or standard interface specifications and protocols and connection services may be presented in one or more windows of a graphical display, as a menu item, as a desktop icon, as a prompt for connection-on-demand type services and in any other suitable form and format. For example, user interfaces may be provided for a variety of consumer devices including mobile devices such as iPhone™, Google phone, Linksys WiFi devices, cell phones, PDAs and so on.

In particular, technically unsavvy users of consumer devices may benefit enormously from point-and-click/touch-and-go access to network services which require or benefit from a shell connection to a terminal service and/or relay service according to certain aspects of the invention. For example, a consumer device user can connect as a shell user in a session that is automatically connected with a hosted terminal client. The traditional input and output of the terminal experience may be hidden or simplified for the shell user. In some embodiments, the shadow user may be in a clear state (see above) and may not see details of shell user activities. The shell user does not need to see the same traditional terminal visual experience as the shadow user.

### Additional Descriptions of Certain Aspects of the Invention

Certain embodiments of the invention provide systems and methods for collaborating in an interactive session. In some of these embodiments, methods comprise the steps of establishing a first connection between a terminal client and a relay service, wherein the terminal client is engaged in an interactive session with a terminal service, creating a second connection between a shadow client and the relay service, and relaying data and commands between the terminal client and the shadow client through the relay service, wherein certain of the data and commands provided by the shadow client are transmitted to the terminal service in the interactive session. In some of these embodiments, the first and second connections are encrypted. In some of these embodiments, the interactive session is encrypted. In some of these embodiments, the interactive session is encrypted using first encryption keys. In some of these embodiments, the first and second connections are encrypted using different encryption keys. In some of these embodiments, the terminal client decrypts the data and commands relayed from the shadow client and re-encrypts certain of the data and commands using the first encryption keys.

Some of these embodiments further comprise providing an encrypted channel between the terminal client and the shadow client, wherein communications in the encrypted channel are relayed without decryption at the relay service. In some of these embodiments, the data and commands include information associated with the interactive session. In some of these embodiments, the information is used to synchronize displays between the terminal client and the shadow client. In some of these embodiments, the information comprises communications between users of the terminal client and the shadow client. In some of these embodiments, the communications between users includes voice communications. In some of these embodiments, the communications between users includes chat.

Some of these embodiments further comprise selectively filtering portions of the data and commands originating at the shadow client. In some of these embodiments, filtering includes blocking user input. Some of these embodiments further comprise selectively filtering portions of the data and commands transmitted by the terminal client. In some of these embodiments, filtering includes blocking user input. Some of these embodiments further comprise creating one or more additional connections between one or more corresponding additional shadow clients and the relay service.

Certain embodiments of the invention provide systems and methods of collaborating in an interactive session. Some of these embodiments comprise establishing a first connection between a terminal client and a relay service, wherein the terminal client is configured to engage in an interactive session with a terminal service, creating a second connection between a shadow client and the relay service, and relaying data and commands between the terminal client and the shadow client through the relay service, wherein certain of the data and commands provided by the shadow client are transmitted to the terminal service in the interactive session. In some of these embodiments, the relayed data and communications comprises communications between users of the terminal client and the shadow client. In some of these embodiments, the communications between users includes voice communications. In some of these embodiments, the communications between users includes chat. Some of these embodiments further comprise logging the data and commands observed at least one of the terminal client, the shadow client and the relay service. In some of these embodiments, logging includes maintaining a history of a terminal service protocol and user interactions.

Certain embodiments of the invention provide systems providing for collaboration in an interactive session. Some of these embodiments perform some or all of the methods described. Some of these embodiments comprise a relay configured to support a plurality of communications channels between terminal clients. In some of these embodiments, the plurality of communications channels includes a collaborative communications channel between a first terminal client and at least one shadow client. In some of these embodiments, the first terminal client establishes the interactive session with a terminal service. In some of these embodiments, the relay synchronizes displays between the first terminal client and the at least one shadow client. In some of these embodiments, the at least one shadow client contributes input to the interactive session. In some of these embodiments, the interactive session is encrypted using first encryption keys. In some of these embodiments, the first and second connections are encrypted using other encryption keys different from the first encryption keys.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method of collaborating in an interactive session, comprising:
establishing a first connection between a terminal client and a relay service, wherein the terminal client is configured to engage in an interactive session with a terminal service;
creating a second connection between a shadow client and the relay service; and
relaying data and commands between the terminal client and the shadow client through the relay service, wherein certain of the data and commands provided by the shadow client are transmitted to the terminal service in the interactive session.

2. The method of claim 1, wherein at least one of the first connection and the second connection is encrypted.

3. The method of claim 1, wherein the interactive session is encrypted.

4. The method of claim 3, wherein the interactive session is encrypted using first encryption keys and wherein the first and second connections are encrypted using different encryption keys.

5. The method of claim 4, wherein the terminal client decrypts the data and commands relayed from the shadow client and re-encrypts certain of the data and commands using the first encryption keys.

6. The method of claim 4, and further comprising providing an encrypted channel between the terminal client and the shadow client, wherein a portion of the communications in the encrypted channel is relayed without decryption at the relay service.

7. The method of claim 6, wherein the portion of the communications includes payload data.

8. The method of claim 1, wherein the data and commands include information associated with the interactive session.

9. The method of claim 8, wherein the information is used to synchronize displays between the terminal client and the shadow client.

10. The method of claim 8, wherein the information comprises communications between users of the terminal client and the shadow client.

11. The method of claim 10, wherein the communications between users includes voice communications.

12. The method of claim 10, wherein the communications between users includes chat.

13. The method of claim 1, and further comprising selectively filtering portions of the data and commands originating at the shadow client.

14. The method of claim 13, wherein filtering includes blocking user input.

15. The method of claim 1, and further comprising selectively filtering portions of the data and commands transmitted by the terminal client.

16. The method of claim 15, wherein filtering includes blocking user input.

17. The method of claim 1, and further comprising creating one or more additional connections between one or more corresponding additional shadow clients and the relay service.

18. The method of claim 1, and further comprising establishing a peer-to-peer communications channel between the terminal client and the shadow client, wherein the peer-to-peer communications channel is provided separately from the first and second connections.

19. The method of claim 1 and further comprising logging the data and the commands observed at least one of the terminal client, the shadow client and the relay service.

20. The method of claim 19, wherein logging includes maintaining a history of a terminal service protocol and user interactions.

21. A system providing for collaboration in an interactive session, comprising a relay configured to support a plurality of communications channels between terminal clients including a collaborative communications channel between a first terminal client and at least one shadow client, wherein the first terminal client establishes the interactive session with a terminal service and wherein the relay synchronizes displays between the first terminal client and the at least one shadow client, the at least one shadow client contributing input to the interactive session.

22. The system of claim 21, wherein the interactive session is encrypted using first encryption keys and wherein the first and second connections are encrypted using other encryption keys different from the first encryption keys.
